(19) United States
(12) Patent Application Publication
(10) Pub. No.: US 2023/0161302 A1
(43) Pub. Date: May 25, 2023

(54) NETWORK FOR FACILITATING TRANSFERS OR MAINTAINANCE OF RESOURCES POST-FABRICATION

(71) Applicant: IP Prism, LLC, Rockledge, FL (US)

(72) Inventor: Katherine Gaudry, Rockledge, FL (US)

(73) Assignee: IP Prism, LLC, Rockledge, FL (US)

(21) Appl. No.: 18/055,035

(22) Filed: Nov. 14, 2022

Related U.S. Application Data
(60) Provisional application No. 63/283,232, filed on Nov. 25, 2021.

(51) Int. Cl. G05B 13/04; G06N 7/01

(52) U.S. Cl. CPC G05B 13/048; G06N 7/01

(57) ABSTRACT

Systems, methods, techniques and communication networks relate to facilitating intelligent and/or efficient evaluation of resource upkeep and/or of resource transfer. Various workflows provide: scores provided by artificial-intelligence tools, facilitation of navigation of big-data population data, and supporting streamlined flows through transfer processes.

### CROSS-REFERENCE TO RELATED APPLICATIONS

This application claims the benefit of and the priority to U.S. Provisional Application No. 63/283,232, filed on Nov. 25, 2021, which is hereby incorporated by reference in its entirety for all purposes.

### BACKGROUND

Configuring a fabrication line is a complicated task. Moving from raw materials and initial design to a properly configured resource frequently involves many steps. If a step is performed with error or generates an output that does not match a planned output (even if the step was properly performed), it may become impossible to generate a target output.

Even if the output is generated (in accordance with the planned output or as a variation of the planned output), its actual functionality, distribution and use can be difficult to predict. For example, an output that does not match a planned output may have reduced functionality and/or may be of reduced utility. As another example, even if an output matches a planned output, a user's operations may be different from operations that were performed when the fabrication line was initially planned, or a user's operations may differ from operations inferred as being associated with the user. In these instances, the utility of the output for the user may be reduced.

The costs of some outputs may not end with those of the fabrication line. Even after the output is generated, an entity tasked with tracking the output (e.g., an original producer or subsequent user) may need to provide additional resource commitment to properly maintain each output. Otherwise, the utility and value of the output may degrade or may disappear. Nonetheless, in operations, it is important to align resources with high-level targets.

In some instances, it may be advantageous to avoid upkeeping the output, as an entity may more highly prioritize generating or using a fabrication line for another output or upkeeping another output. Further, while such resource degradation may be consistent with one entity's approach, another entity's approach may be different. Thus, a partial or full transfer of the resource may be advantageous. However, any such transfer may be further limited when there are initial constraints and/or information that apply to the output, especially if such constraints and/or information are known to only one or more select entities and not others. This situation may result in the transfer process never being initiated at all, a transfer not being completed, or a transfer being incomplete due to insufficient information conveyances.

### SUMMARY

In some embodiments, a system is provided that includes: a dynamic specification investigator that determines, for each content representation of a set of content representations and based on data from at least one data source, a set of specifications of the content representation, where each content representation defines a resource, and where at least one specification that characterizes a point along a navigation towards the corresponding resource; an artificial-intelligence (AI) operation predictor that: predicts, for each specification of the set of specifications corresponding to each of at least one the set of content representations, a value for the specification; and determines, for each of the at least one of the set of content representations, a score for the content representation based at least in part on the predicted value of each of the set of the specifications corresponding to the content representation; a transfer controller that: presents the score for a particular content representation of the set of content representations and an input component configured to receive an indication as to whether to initiate a transfer process for the particular content representation; and detects an input via the input component that indicates that the transfer process is to be initiated for the particular content representation; and a reach system that initiates the transfer process for the particular content representation.

The system may further include a constraint controller that: detects, for a content representation of the set of content representations, one or more constraints that apply to transfer of the content representation; and constrains the reach system in terms of the output generation or updating so as to not initiate a discordance of the one or more constraints.

The constraint controller may alternatively or additionally detect, for a particular content representation of the set of content representations, one or more constraints that apply to transfer of the content representation; where the reach system is further configured to receive a request for the content representation; and where the constraint controller may be further configured to verify that the request accords with the one or more constraints.

The score determined by the AI operation predictor may pertain to a particular entity; the AI operation predictor may further determine, for each of at least one of the set of content representations, another score for the content representation corresponding to another entity, where the score is higher than the other score; and the reach system may preferentially generate or preferentially update an output corresponding to the potential transfer of the particular content representation to the particular entity over that to the other entity based on the score being higher than the other score.

The system may include an aggregator controller that generates multiple clusters of content representations across the set of content representations, the content representation being assigned to a particular cluster of the multiple clusters; where the AI operation predictor may further aggregate the score for the content representation with each other score corresponding to other content representations in the cluster; and where the transfer controller may present the aggregated score.

For a particular specification of the set of specifications, the AI operation predictor may predict the value using a Bayesian computation.

Transfer of the particular content representation may include transfer of the resource defined by the particular content representation.

In some embodiments, a system is provided that includes: a resource identification transformer that identifies one or more specifications of a content representation of a resource; a dynamic specification investigator that detects a value of one or more dynamic specifications; and an AI operation predictor that: projects a subsequent version of the content representation based on the one or more specifications of the content representation and the one or more dynamic specifications; transmits one or more values of the subsequent version of the content representation; and receives, in response to the transmission, an instruction to modify a workflow for upkeeping the content representation; and a reach system that initiates a transfer process for the content representation.

The value of the one or more dynamic specifications may include a status of each of one or more other resources.

The one or more values of the subsequent version of the content representation may include a value acceptable via a rule of a transfer-control system for listing the content representation, and the instruction to modify the workflow may include an instruction to list the content representation for the value at the transfer-control system.

The one or more values of the subsequent version of the content representation may include a predicted probability of a given entity performing an action to maintain an existence of the resource and the one or more dynamic specifications includes a status of each of one or more other resources.

Modifying the workflow may include changing a state of a switch that indicates whether a given action is to be initiated.

The workflow may include multiple lines of action, where each of the multiple lines of action is initiated by a trigger, and the modification of the workflow by the trigger controller may include setting a trigger of at least one of the multiple lines.

Modifying the workflow may include modifying a representation of a task in the workflow to facilitate transforming the resource from a first state to a second state.

The subsequent version of the content representation may be or may have been projected by using a probabilistic map that relates content-representation features to probabilities of at least one action within the workflow being performed.

The projected subsequent version of the content representation at the subsequent time may represent a prediction as to whether (or a likelihood that) an enhanced version of the content representation will have been obtained.

In some embodiments, a system is provided that includes: a resource identification transformer that: identifies a set of distinct content representations, each of the set of distinct content representations corresponding to a resource; transforms each of the set of distinct content representations include a reduced content representation; and facilitates presenting the reduced-content representations at a first interface associated with a client system; an aggregator controller that: detects that a trigger was received at the interface for generating a cluster for two or more of the set of distinct content representations; links the two or more content representations via a link; a reach system that: receives, via a second interface, a request that includes one or more content specifications; and a transfer controller that: detects that the one or more content specifications correspond to a first content representation of the two or more content representations; and detects that the first content representation is linked to each other of the two more content representations, where the reach system is further configured to facilitate a presentation indicating that the first content representation is linked to each other of the two or more content representations.

The aggregator controller may further: determine that the link is a weak link that permits removal of any individual content representation of the two or more content representations from the cluster.

The two or more of the set of distinct content representations may include three or more of the set of distinct content representations; the aggregator controller further may determine that the link is a weak link that permits removal of any individual content representation of the two or more content representations from the cluster; the reach system may detect a transfer request for a particular individual content representation from the cluster; the aggregator controller, in response to the transfer request or a corresponding related action, redefines the cluster; and the redefined cluster may lack or not include the particular individual content representation.

The aggregator controller may, for each resource of a set of resources corresponding to a client: identify a set of features based on specifications corresponding to the resource; generate a point in a multi-dimensional space based on the set of features; and generates a presentation that includes a graphical representation of the points and that facilitates groupings of each of one or more subsets of the points to identify a corresponding cluster, where the interface may display the presentation, where the cluster was generated in response to a user-identified grouping of the two or more of the set of distinct content representations, and where each of the two or more of the set of distinct content representations may have included a corresponding generated point in the multi-dimensional space.

The aggregator controller may: identify a tree that relates at least two of the two or more content representations and facilitate a presentation, prior to the detection of the trigger, in the second interface that identifies the tree.

The aggregator controller may: identify, for each of the two or more content representations, a status of the resource corresponding to the content representation, where the presentation that identifies the tree further identifies the status.

In some embodiments, a system may include: a resource identification transformer that: identifies a content representation that corresponds to a resource; detects a resource-communication limitation for the resource that indicates that communication of specific information is to be restricted, the specific information indicating one or more constraints that apply on transfer of the resource; and transforms the content representation to a reduced content representation that identifies one or more select portions of the content representation and metadata indicating that a resource-communication limitation applies to the reduced-content representation; a reach system that: facilitates presenting the reduced-content representation via a first interface to one or more user devices associated with a client system; detects, via the first interface and from a user device (not associated with the patent owner) of the one or more user devices, a request for transfer of the resource corresponding to the content representation; detects that the request for transfer of the resource corresponding to the content representation is associated with the metadata indicating that a resource-communication limitation applies; causes a first communication to be sent to a device corresponding to the user device requesting acceptance that a disclosure restriction applies to presentation of the specific information; receives a second communication from the user device that corresponds to acceptance of the disclosure restriction; transmits a third communication to a device corresponding to an entity controlling the resource that identifies another entity corresponding to the user device and that indicates that the request the disclosure restriction has been accepted by the other entity; determines whether the other entity is authorized to receive the specific information; and throttles communication of the specific information to the other entity based on the determination as to whether the other.

Throttling the communication may include transmitting the specific information to the other entity when it is determined that the other entity is authorized to receive the specific information. In some instances, throttling the communication includes refraining from transmitting the specific information to the other entity when it is determined that the other entity is not authorized to receive the specific information.

Determining whether the other entity is authorized to receive the specific information may include determining whether another communication has been received responsive to the third communication that indicates that the other entity is authorized to receive the specific information.

Determining whether the other entity is authorized to receive the specific information may include determining whether another communication has been received, within a predetermined period of time from transmission of the third communication, responsive to the third communication that indicates that the other entity is authorized to receive the specific information.

In some embodiments, a computer-implemented method is provided that includes: determining, for each content representation of a set of content representations and based on data from at least one data source, a set of specifications of the content representation, where each content representation defines a resource, and where at least one specification that characterizes a point along a navigation towards the corresponding resource; predicting, for each specification of the set of specifications corresponding to each of at least one the set of content representations, a value for the specification; determining, for each of the at least one of the set of content representations, a score for the content representation based at least in part on the predicted value of each of the set of the specifications corresponding to the content representation; presenting the score for a particular content representation of the set of content representations and an input component configured to receive an indication as to whether to initiate a transfer process for the particular content representation; detecting an input via the input component that indicates that the transfer process is to be initiated for the particular content representation; and initiating the transfer process for the particular content representation.

The method may further include, for a content representation of the set of content representations: detecting one or more constraints that apply to transfer of the content representation; and constraining the output generation or updating so as to not initiate a discordance of the one or more constraints.

The method may alternatively or additionally include, for a particular content representation of the set of content representations, detecting one or more constraints that apply to transfer of the content representation; receiving a request for the content representation; and verifying that the request accords with the one or more constraints.

The score determined by the AI operation predictor may pertain to a particular entity; the method may include determining, for each of at least one of the set of content representations, another score for the content representation corresponding to another entity, where the score is higher than the other score; and preferentially generating or preferentially updating an output corresponding to the potential transfer of the particular content representation to the particular entity over that to the other entity based on the score being higher than the other score.

The method may include generating multiple clusters of content representations across the set of content representations, the content representation being assigned to a particular cluster of the multiple clusters; where score for the content representation may be aggregated with each other score corresponding to other content representations in the cluster; and the aggregated score may be presented.

For a particular specification of the set of specifications, the value may be predicted using a Bayesian computation.

Transfer of the particular content representation may include transfer of the resource defined by the particular content representation.

In some embodiments, a method is provided that includes: identifying one or more specifications of a content representation of a resource; detecting a value of one or more dynamic specifications; projecting a subsequent version of the content representation based on the one or more specifications of the content representation and the one or more dynamic specifications; transmitting one or more values of the subsequent version of the content representation; receiving, in response to the transmission, an instruction to modify a workflow for upkeeping the content representation; and initiating a transfer process for the content representation.

The value of the one or more dynamic specifications may include a status of each of one or more other resources.

The one or more values of the subsequent version of the content representation may include a value acceptable via a rule of a transfer-control system for listing the content representation, and the instruction to modify the workflow may include an instruction to list the content representation for the value at the transfer-control system.

The one or more values of the subsequent version of the content representation may include a predicted probability of a given entity performing an action to maintain an existence of the resource and the one or more dynamic specifications includes a status of each of one or more other resources.

Modifying the workflow may include changing a state of a switch that indicates whether a given action is to be initiated.

The workflow may include multiple lines of action, where each of the multiple lines of action is initiated by a trigger, and the modification of the workflow by the trigger controller may include setting a trigger of at least one of the multiple lines.

Modifying the workflow may include modifying a representation of a task in the workflow to facilitate transforming the resource from a first state to a second state.

The subsequent version of the content representation may be or may have been projected by using a probabilistic map that relates content-representation features to probabilities of at least one action within the workflow being performed.

The projected subsequent version of the content representation at the subsequent time may represent a prediction as to whether (or a likelihood that) an enhanced version of the content representation will have been obtained.

In some embodiments, a compute-implemented method is provided that includes: identifying a set of distinct content representations, each of the set of distinct content representations corresponding to a resource; transforming each of the set of distinct content representations include a reduced content representation; facilitating presenting the reduced-content representations at a first interface associated with a client system; detecting that a trigger was received at the interface for generating a cluster for two or more of the set of distinct content representations; linking the two or more content representations via a link receiving, via a second interface, a request that includes one or more content specifications; detecting that the one or more content specifications correspond to a first content representation of the two or more content representations; detecting that the first content representation is linked to each other of the two more content representations, facilitating a presentation indicating that the first content representation is linked to each other of the two or more content representations.

The method may include: determining that the link is a weak link that permits removal of any individual content representation of the two or more content representations from the cluster.

The two or more of the set of distinct content representations may include three or more of the set of distinct content representations; the method may further include: determining that the link is a weak link that permits removal of any individual content representation of the two or more content representations from the cluster; detecting a transfer request for a particular individual content representation from the cluster; redefining, in response to the transfer request or a corresponding related action, the cluster; where the redefined cluster may lack or not include the particular individual content representation.

For each resource of a set of resources corresponding to a client: identify a set of features based on specifications corresponding to the resource; a point in a multi-dimensional space may be generated based on the set of features; and a presentation may be generated that includes a graphical representation of the points and that facilitates groupings of each of one or more subsets of the points to identify a corresponding cluster, where the interface may display the presentation, where the cluster may have been generated in response to a user-identified grouping of the two or more of the set of distinct content representations, and where each of the two or more of the set of distinct content representations may have included a corresponding generated point in the multi-dimensional space.

The method may include identifying a tree that relates at least two of the two or more content representations and facilitate a presentation, prior to the detection of the trigger, in the second interface that identifies the tree.

The method may include identifying, for each of the two or more content representations, a status of the resource corresponding to the content representation, where the presentation that identifies the tree further identifies the status.

In some embodiments, a method may include: identifying a content representation that corresponds to a resource; detecting a resource-communication limitation for the resource that indicates that communication of specific information is to be restricted, the specific information indicating one or more constraints that apply on transfer of the resource; transforming the content representation to a reduced content representation that identifies one or more select portions of the content representation and metadata indicating that a resource-communication limitation applies to the reduced-content representation; facilitating presenting the reduced-content representation via a first interface to one or more user devices associated with a client system; detecting, via the first interface and from a user device of the one or more user devices, a request for transfer of the resource corresponding to the content representation; detecting that the request for transfer of the resource corresponding to the content representation is associated with the metadata indicating that a resource-communication limitation applies; causing a first communication to be sent to a device corresponding to the user device requesting acceptance that a disclosure restriction applies to presentation of the specific information; receiving a second communication from the user device that corresponds to acceptance of the disclosure restriction; transmitting a third communication to a device corresponding to an entity controlling the resource that identifies another entity corresponding to the user device and that indicates that the request the disclosure restriction has been accepted by the other entity; determining whether the other entity is authorized to receive the specific information; and throttling communication of the specific information to the other entity based on the determination as to whether the other.

Throttling the communication may include transmitting the specific information to the other entity when it is determined that the other entity is authorized to receive the specific information. In some instances, throttling the communication includes refraining from transmitting the specific information to the other entity when it is determined that the other entity is not authorized to receive the specific information.

Determining whether the other entity is authorized to receive the specific information may include determining whether another communication has been received responsive to the third communication that indicates that the other entity is authorized to receive the specific information.

Determining whether the other entity is authorized to receive the specific information may include determining whether another communication has been received, within a predetermined period of time from transmission of the third communication, responsive to the third communication that indicates that the other entity is authorized to receive the specific information.

In some embodiments, a system is provided that includes one or more processors; and a computer program product comprising a non-transitory computer-readable medium having a computer readable program, wherein the computer readable program, when executed on the one or more processors, causes the one or more processors to perform part or all of one or more methods, part or all of one or more processes, and/or one or more actions disclosed herein.

In some embodiments, a computer program product is provided that includes a non-transitory computer-readable medium having a computer readable program, wherein the computer readable program, when executed on one or more processors, causes the one or more processors to perform part or all of one or more methods, part or more of one or more processes, and/or one or more actions disclosed herein.

### BRIEF DESCRIPTION OF FIGURES

Select embodiments of the present invention are described, by way of examples only, with reference to the accompanying drawings, where:

FIG. 1 illustrates an exemplary network 100 for using artificial intelligence (AI) and/or distributed processing to facilitate generating, maintaining, and/or transferring resources and/or content representations thereof

FIG. 2 illustrates an exemplary interaction network between select components of an exemplary network to collect and/or transform specifications pertaining to individual resources to facilitate initiation of, progression of, and/or completion of resource transfers.

FIGS. 3A-3C illustrate aggregations of content representations into clusters.

FIG. 4 illustrates an exemplary representation of verification results for a tree corresponding to a particular content representation that an entity requests be initialized for transfer facilitation.

FIGS. 5A-5C show exemplary interfaces for facilitating decisions pertaining to content representation.

### DESCRIPTION

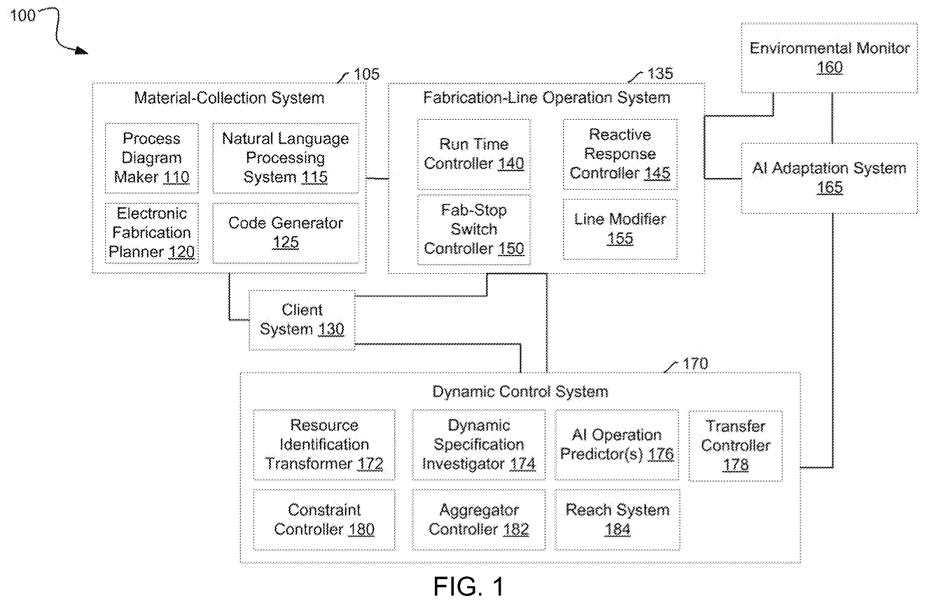

FIG. 1 illustrates an exemplary network 100 for using artificial intelligence (AI) and/or distributed processing to facilitate generating, maintaining, and/or transferring resources and/or content representations thereof.

A material-collection system 105 can generate or collect some or all starting materials for a fabrication line that is to be configured to retrieve or generate a content representation of target resource. The materials may include an initial version of a content representation of the target resource, with the initial version of the content representation identifying how to generate and use a given output (e.g., a given process, composition, manufacture, or machine).

In some instances, material-collection system 105 merely retrieves the content representation(s) of the target resource. In some instances, material-collection system at least partially generates the content representation of the target resource (e.g., by generating content and/or metadata of the content representation).

Material-collection system 105 can include a process diagram maker 110 that can generate diagram (e.g., a flowchart) that identifies (for example) one or more steps for producing or using the given output. Material-collection system 105 can include a natural language processing system 115 configured to generate or process text (e.g., a specification and/or claims in the content representation) that describes the given output. For example, natural language processing system 115 may be configured to detect errors or inconsistencies in input text. Material-collection system 105 can include an electronic fabrication planner 120 that generates a plan (e.g., that includes text and/or one or more drawings) as to how to build or configure electronics (e.g., a computing system that includes one or more processors and one or more memories that store instructions that, when executed by the processor(s) perform steps in the invention) in a manner aligned with the output. Material-collection system 105 can include a code generator 125 that may generate computer code aligned with the output and/or may generate one or more specifications that (for example) specify the output.

In some instances, material-collection system 105 collects (e.g., receives) some or all of the materials from a client system 130 or a client. For example, client system 130 may upload and/or transmit a materials file to material-collection system 105. As another example, material-collection system 105 may include or may be an application on client system 130 that receives input via an input component (e.g., keyboard, mouse, trackpad, etc.) from the client or that receives one or more files generated using one or more other applications on client system 130. For example, material-collection system 105 may be a browser installed on and/or executing on client system 130 that facilitates receiving an upload of the materials (e.g., the one or more files).

A fabrication-line operation system 135 may receive the materials from material-collection system 105 and facilitate operation of a fabrication line to generate the target resource by generating an enhanced version of a content representation. A run time controller 140 can load the material(s) and initiate running of the production line. The initiation may be (for example) triggered in response to receiving a corresponding instruction from client system 130 or a corresponding client (e.g., via an input interface). For example, run time controller 140 can include a browser that initiates transmission of a request to file a version (e.g., an initial version) of a content representation in response to receiving an input from client system 130 or a client (via an input interface) to request the filing. A reactive response controller 145 can monitor the operation line, detect any feedback generated as the material(s) are processed, facilitate determining whether and/or how to respond to the feedback, and/or generate any response to the feedback. Reactive response controller 145 may determine whether and/or how to respond to the feedback based on (for example) learned parameters to process the feedback. For example, the feedback may identify a particular missing material, which reactive response controller 145 may identify (e.g., using a trained machine-learning model) and submit. As another example, reactive response controller 145 may facilitate converting input from client system 130 or a corresponding client into a responsive file and/or transmitting a responsive file generated by client system 130 or input from a client. As yet another example, the feedback may (e.g., accurately or erroneously) contend that a submitted content representation includes an error. Reactive response controller 145 may use artificial intelligence to detect the error and may then generate a strategy or file for responding to the contention.

A fab-stop switch controller 150 can indicate whether the fabrication line is to continue operating. Continuing to operate the fabrication line can include (for example) responding to any feedback from a given source and/or continuing to monitor or process feedback pertaining to the fabrication line. Fab-stop switch controller 150 can set a fab-stop switch that corresponds to a given fabrication line and a given target resource to indicate with the fabrication line is operational. If the fabrication line is operation, responding to feedback pertaining to the fabrication line may be prioritized. If the fabrication is not operational, responding to feedback pertaining to the fabrication line may be de-prioritized and/or the feedback may be discarded. De-prioritizing the fabrication line can include deprioritizing or stopping particular mechanisms configured to generate initial or intermediate products responsive to feedback.

A line modifier 155 can initiate modifying the fabrication line to (for example) adjust an approach for responding to feedback and/or adjust a timing for responding to feedback. Adjusting an approach for responding to feedback may include (for example) adjusting whether, when, and/or in which circumstances to initiate moving the fabrication line to a different reviewing entity. As another example, adjusting an approach for responding to feedback may include generating a new version of a content representation. Line modifier 155 can determine whether and/or how to modify a fabrication line (or to recommend whether and/or how to modify a fabrication line) based on (for example) a current or recent efficiency of the fabrication line and/or a predicted success of the fabrication line. For example, line modifier 155 may determine whether and/or how to recommend a new line strategy based on an empirical statistic that identifies a line-completion rate or an average number of steps in a line for a current decision-maker

An environmental monitor 160 can monitor one or more dynamic variables, which may pertain to the line operation. The one or more dynamic variables may include (for example) how many other content representations corresponding content representation being processed in the fabrication line are being or have been generated and/or finalized. The one or more dynamic variables may alternatively or additionally identify how many other outputs corresponding to an output identified in the content representation being processed in the fabrication line are being generated and/or distributed. The one or more dynamic variables may include an external variable. Any component of fabrication-line operation system 135 may adjust an action based on the dynamic variable(s). For example, run time controller 140 may determine whether to initiate or whether to recommend initiating the fabrication line based at least in part on the dynamic variable(s). As another example, reactive response controller 145 may weigh the dynamic variable(s) when determining whether and/or how to respond to feedback. Responding to the dynamic feedback(s) can include generating a new version of the content representation and/or generating a response to the feedback. As yet another example, fab-stop switch controller 150 may use the dynamic variable(s) in its evaluation to determine whether to proceed with or stop (or whether to recommend proceeding with or stopping) the fabrication line.

A component of fabrication-line operation system 135 may determine how to adjust its actions based on the dynamic variable(s) by (for example) using one or more previously defined parameter values, using one or more previously learned parameter values, or learning one or more parameter values. For example, a component may use a model to transform received variables into a result that (for example) indicates whether to initiate a run, whether and/or how to react to feedback, a setting for a fab-stop switch, and/or whether and/or how to modify a lane. The model may be defined based on a set of parameters, and each of the set of parameters may have a value (e.g., a learned or defined variable). The model may include (for example) a regression model or a neural network. The received variables may include the one or more dynamic variables, such that the component's result depends on the dynamic variable(s). Alternatively or additionally, one or more conditions may be defined to depend on the dynamic variable(s). For example, run time controller 140 may determine whether to initiate a fabrication line based at least partly on the dynamic variable(s), and/or fab-stop switch controller 150 may determine whether to change a state of the fab-stop switch based at least in part on the dynamic variable(s).

An AI adaptation system 165 may monitor characteristics of input materials and/or dynamic variables and to determine whether and/or how to adapt one or more model architectures, one or more algorithms (e.g., in terms of algorithm selection or configuration), one or more hyperparameters, etc. For example, AI adaptation system 165 may evaluate a condition to determine whether recent values of a dynamic variable (or of an input-material variable) conform with a given change characteristic as specified in the condition to predict that a current model used by run time controller 140, reactive response controller 145, fab-stop switch controller, or line modifier 155 is likely to generate less accurate predictions (e.g., as to whether and/or when run time is optimally initiated, how to react to feedback, whether and/or when to flip the fab-stop switch, and/or whether and/or how to modify a line) relative to another model. AI adaptation system 165 may then initiate a switch to the other model, which may occur automatically or upon authorization from a client or client system 130.

Fabrication-line operation system 135 may terminate with generation of a final version of a content representation and/or a final version of a resource corresponding to the final version of the content representation. A dynamic control system 170 can facilitate control of whether and/or how the final version of the content representation (“content representation”) and/or corresponding resource are pursued and/or accepted by a party that controls the content representation.

A resource identification transformer 172 can identify one or more specifications (i.e., one or more characteristics) of the content representation. The specification(s) or characteristic(s) may characterize a past, current, or potential future attribute of the content representation and/or corresponding resource. For example, the specification(s) may characterize a subject matter of the content representation (e.g., a technological classification), a characteristic of an entity that initiated generation of the content representation, an entity (e.g., examiner or art unit) that previously evaluated a same or previous version of the content representation, a jurisdiction that evaluated a same or previous version of the content representation, a size of part or all of the content representation (e.g., a word count of a claim, a number of claims, a page count of a section of the content representation, a page count of the content representation, etc.), etc. It will be appreciated that a specification of a content representation may include a metadata variable that does not characterize the content in the content representation but instead characterizes an aspect of how and why the content representation was generated and/or how the content representation is being received or transformed. Meanwhile, a specification of a content representation may alternatively characterize content in the content representation. In some instances, each of one or more first specifications characterize content in the content representation and each of one or more second specifications do not. Each of the specification(s) identified by resource identification transformer 172 may be a value of a static variable that is fixed in time or an initial or most-recent value of a dynamic variable.

In some instances, resource identification transformer 172 may determine that one or more content representations correspond to metadata indicating a resource-communication limitation applies. The resource-communication limitation may apply when the listing includes content in a particular portion of the listing (e.g., which may then be defined access-restrained specific information). The particular portion may identify one or more particular encumbrances that apply to the listing. When it is determined that the resource-communication limitation applies, resource identification transformer 172 may transform the content representation(s) to a reduced content representation, where the reduced content representation lacks one or more select portions (e.g., the particular portion) and instead includes one or more other select portions (e.g., not including the particular portion).

A dynamic specification investigator 174 may retrieve or pull a current value of a dynamic specification. For example, dynamic specification investigator 174 may pull or may receive data identifying specifics of an evaluation assigned for the content representation (e.g., an enhanced version of a patent application or another version), a status of the evaluation, characteristics of an entity controlling the content representation, etc.

In some instances, dynamic specification investigator 174 can determine the current value of a dynamic specification based on a deterministic algorithm. In some instances, dynamic specification investigator 174 determines the current value based on one or more recent values of the specification and/or a value of each of one or more other dynamic variables. For example, dynamic specification investigator 174 may identify or predict a current or future value based on how many other content representations (e.g., that are associated with the entity controlling a content representation foe which the dynamic specification is being identified and/or that are associated with one or more other entities) are related to the content representation and/or the status and geographical correspondence of each other content representation. Dynamic specification investigator 174 may identify or determine the current or future value of the specification by retrieving one or more values from a remote source, using one or more locally identified values, comparing (e.g., using a loss function) recent value predictions to true values, etc.

Each of one or more AI operator predictor 176 can predict, for each specification of at least one, more or all static or dynamic specifications and/or a future value of a specification. For a static specification, AI operator predictor 176 may use a rules-based approach to determine whether a value has been assigned to the specification. If so, the predicted value may be the same as the assigned value (e.g., within a given recent time period). If not, AI operator predictor 176 may turn to a machine-learning model (or another rules-based technique) to predict what the value will be. For example, the value may be predicted based on other values set for the static specification for other content representations corresponding to other resources. As another example, the value may be predicted based on a formulaic time-dependency function (e.g., that identifies a potential, maximum, or actual lifespan of a resource in a linear manner based on one or more specifications and a current or future date).

For a dynamic specification, AI operator predictor 176 may use a machine-learning model or a rules-based approach to predict a value. For example, a numeric value of a specification may be predicted by feeding a set of previous values for the specification to a regression model. As another example, a categorical value may be predicted by feeding set of recent values for a set of specifications to a classifier model (e.g., a decision-tree model, random forest model, a Markov chain model, etc.). As yet another example, a numeric value of a specification may be predicted based on an equation (e.g., by calculating a remaining term of a resource by subtracting a current date from an expiration date). As yet another example, a numeric value or categorical value of a specification may be predicted using a Bayesian computation and/or by randomly or pseudo randomly selecting a value from a distribution (e.g., a prior distribution or posterior distribution) generated using based on previous values of the specification (e.g., for the same content representation or as observed across multiple content representations).

AI operation predictor 176 can determine, for a given content representation, a score for the content representation based on the current and/or predicted value of each of one or more specifications (e.g., one or more dynamic specifications and/or one or more static specifications). The score may be a numeric score along a scale (e.g., a score that is a number between 0 and 100) or a categorical score. Determining the score may include using a machine-learning model (e.g., a regression model, a decision-tree model, a random-forest model, a Markov chain model, a Boosted tree model, a feedforward neural network, a long short-term memory network, a recurrent neural network, etc.) to process the current and/or predicted values.

In an instance when a content representation has not completed the fabrication line, the score may identify a predicted probability that the fabrication line will be completed and the target resource and/or an enhanced version of the content representation will be obtained. Such a score may also depend on one or more predictions as to a specification of a potentially secured enhance version of a content representation and/or a predicted time for completing the fabrication line. In an instance when a content representation has completed the fabrication line, the score may identify a predicted probability that the resource defined by the content representation will be maintained.

In some instances, the machine-learning model that is used to predict the score may have been trained using data pertaining to other content representations (e.g., that are associated with a same entity as an entity associated with the content representation for which the score is generated and/or that associated with one or more other entities). For example, a same entity may own some or all of the content representations associated with a training set used to train the machine-learning model and the content representation for which the score is generated. Thus, the machine-learning model may be specifically trained for a single entity. The machine-learning model may then be trained to predict (for example) a likelihood that an applicant will complete the fabrication line (e.g., an examination process) and secure a resource (versus abandoning the content representation). As another example, the machine-learning model may be trained to predict a likelihood that an owner of a resource will upkeep or maintain the resource by paying each of one or more maintenance fees.

In some instances, the machine-learning model that is used to predict the score may have been trained using data pertaining to other content representations that are associated with the entity associated with the content representation for the score is generated and/or one or more different entities. The one or more different entities may include or may be associated with one or more entities identified by a user that requested the score and/or that controls content representations (e.g., enhanced content representations) having one or more specifications that are the same as or close to those of the content representation. For example, the machine-learning model may have been trained using content representations associated with a same classification (e.g., but corresponding to different entities). In some instances, the machine-learning model learns how a classification of a content representation is predicted to impact the score.

Thus, the machine-learning model may be trained to output a prediction as to (for example) a likelihood that the fabrication line would be completed for the content representation or that the content representation would be maintained if the one or more other entities were controlling corresponding decisions (e.g., as to a state of fab-stop switch controller 150 or as to whether to initiate a maintenance event). In some instances, a score generated by a machine-learning model associated with a first entity not associated with the content representation may be higher than a score generated by another machine-learning model associated with a second entity that is associated with the content representation. The other machine-learning model may have a same or different model architecture as compared to that of the machine-learning model and may have different parameter values compared to those of the machine-learning model. This may suggest that the first entity would prioritize the content representation more so than does the second entity.

In some instances, AI operation predictor 176 projects a subsequent version of the content representation based on one or more specifications. The subsequent version may be an enhanced version and/or a version defined to include current content in the content representation and a different and/or state of the content representation. For example, the subsequent version may be defined to differ from a current version of the content representation only by a state variable, which can indicate whether or not a particular upkeep action was performed. For example, the subsequent version may include a version where an upcoming maintenance amount is submitted, or the subsequent version may include a version of the content representation (an expired version) where an upcoming maintenance amount is not submitted. As another example, the subsequent version may include one in which a current content representation issues as an enhanced version of the content representation (e.g., immediately or after a predefined time delay). To illustrate, the subsequent version may correspond to a hypothetical enhanced version of the content representation that issues on a specified date and that includes the same text (and same claims) as in a current content representation. AI operation predictor 176 may further generate a probability metric that identifies a predicted likelihood of the content representation transitioning to the subsequent version of the content representation.

Projecting the subsequent version of the content representation can include identifying a set of features of the content representation (e.g., a current version of the content representation), identifying a position within a feature map (or embedding space) that corresponds to the set of features and identifying a probability of transitioning to a particular state (e.g., an enhanced version of the content representation) based on the position. Each of the set of features may include or may be based on one or more specifications of the content representation. The features may have been identified based on (for example) a component analysis (where each feature corresponds to a component) or by training a machine-learning model. The component analysis, machine-learning model and/or a clustering assessment may further be used to define a relationship that can associate each position within the feature map to a probability of transitioning to the particular state. For example, an embedding space may be defined so that positions within the space smoothly vary with probabilities that an initial version of a content representation will transition to be an enhanced version of the content representation and/or to facilitate identifying one or more distinct clusters that correspond to different likelihoods of such transitions.

AI operation predictor 176 can generate or obtain one or more values of the subsequent version of the content representation. The one or more values may include (for example) a value of a dynamic specification and/or a score. For example, the one or more values may include a remaining term for the resource that corresponds to the (e.g., enhanced) version of the content representation or a score predicting a likelihood that an entity that controls the resource will maintain the resource (e.g., at one or more specific time points). The one or more values may include a probability metric that identifies a predicted likelihood of the content representation transferring to a subsequent version or to the enhanced version of the content representation.

In some instances, a particular network controller sets rules for transfer of content representations, which may define or limit a listing amount for each content representation (or for a group of content representations) based on one or more specifications of the content representation(s). The one or more values may additionally or alternatively identify the listing amount or its limit for the subsequent version of the content representation. AI operation predictor 176 can transmit the one or more values to client system 130. Client system 130 may present the information, receive input via an input interface (e.g., from a user), generate a responsive communication and transmit the responsive communication to dynamic control system 170.

The responsive communication can include an instruction to modify a workflow. The responsive communication may further include or may indicate one or more constraints or particulars and/or defining attributes for the modification of the workflow. For example, a constraint of a listing of a resource as being available for transfer may include an indication that the transfer requires that the client (e.g., and potentially one or more other entities, such as subsidiary entities) have continued rights (e.g., to make, use and/or distribute) to the resource.

As another example, a particular listing of a resource may condition under which conditions the resource is permitted to be asserted (e.g., which may include identifying one or more parties with existing rights pertaining to the resource). As yet another example, a particular listing of a resource may require that each remaining maintenance amount be submitted. As still another example, a particular listing of a resource may require that all of a set of resources be concurrently purchased as opposed to purchasing an incomplete subset.

Modifying the workflow can include changing a state of a switch that indicates whether a given action is to be initiated. The switch may include (for example) the fab-stop switch that controls fabrication line or that defines how the fabrication line is to be operated (e.g., whether a responsive file is to be submitted, whether an amount is to be submitted, etc.). The switch may include an upkeep switch that controls or defines whether a task is to be performed that will cause the content representation to transition between states (e.g., by submitting or not submitting a maintenance amount by a deadline). The switch may include a transfer switch that controls or defines whether the content representation is to be listed for potential transfer. In some instances, rather than or in addition to setting a state of a switch, modifying the workflow can include setting a trigger to initiate a line of action (e.g., to initiate listing a content representation).

A transfer controller 178 can be configured to, in response to receiving a corresponding instruction to list a content representation, to initiate a reach for the content representation. Before initiating the reach, transfer controller 178 can collect information pertaining to the content representation. The information can include one or more specification values, an identifier (e.g., a numeric identifier) of the content representation, and/or part or all of the content in the content representation. Transfer controller 178 may further collect information from one or more third-party sources and/or may refresh previously collected data to be current. In some instances, transfer controller 178 performs one or more evaluations to determine whether a revised approach may improve a likelihood of a successful transfer. As one example, transfer controller 178 may predict that a listing amount is sufficiently different (e.g., in terms of an absolute amount or percentage) than a predicted transfer amount or that a listing threshold is sufficiently below a predicted transfer amount. Transfer controller 178 may transmit a communication to client system 130 that includes a query as to whether the client selects a modification of the listing amount or limit in view of the predicted metrics.

As another example, transfer controller 178 may detect whether the content representation is related to (e.g., in a same family tree as) one or more other content representations (e.g., having one or more specific statuses) and whether the one or more other content representations are also identified for reach initiation and/or are linked to the content representation (e.g., via a transfer constraint or based on a particular as to how a listing is to be generated). If one or more other related content representations (e.g., having one or more specific statuses) are identified but are not associated with content representation via an aggregation, link or constraint, transfer controller 178 may transmit a query to client system 130, where the query identifies the one or more other related content representations and queries whether to generate an aggregation, link, or constraint.

Transfer controller 178 may generate an object that identifies or indicates the collected information and/or any transfer constraints. The object may include (for example) an HTML, file, an image, text, etc. that defines a visual presentation that identifies transfer particulars corresponding to the content representation. The object may further or alternatively include code, pseudocode or text that identifies additional information about the potential transfer (e.g., including an identifier for an entity owning the content representation). The object may, but need not, identify an entity that requested the transfer initiation and/or that owns the content representation.

A constraint controller 180 may detect, track, and/or facilitate enforcement of each constraint pertaining to an initiation of a potential transfer. Constraint controller 180 may identify each of one or more potential constraints, may alert client system 130 of each potential constraint, may track each constraint that client system 130 indicates is to be associated with a given content representation, and may link the constraint(s) linked to a content representation with the content representation. Linking the constraint(s) to the content representation may include (for example) integrating data or a data object identifying the constraint(s) with or into a data object identifying the content representation or generating and effecting functional code that restricts completion of an action pertaining to the content representation (e.g., of a transfer of a content representation) based on a determination that the constraint(s) are satisfied. In some instances, a condition for effecting any transfer is to receive a confirmation from constraint controller 180 that each applicable constraint is satisfied. Linking the constraint(s) to the content representation may alternatively or additionally include assessing a request for the content representation from another entity to determine whether the requested transfer to the other entity would comply with each applicable constraint.

A constraint may include linking a single content representation to one or more other related content representations, so as to condition the transfer of the single content representation on the one or more other related content representations being transferred as well. The one or more other related content representations may include one, more or all other content representations identified in a resource tree as the single content representation or may be related in another manner (e.g., pertaining to similar subject matters or identified as being related by an entity that controls the single content representation before the transfer). An aggregator controller 182 may define and effectuate this constraint by defining a cluster that may be defined to include a representation of the single content representation and the one or more other related content representations.

For example, aggregator controller 182 may initiate a presentation of an interface that includes an identification of each content representation associated with a client. The identification may include (for example) a point in a multi-dimensional space where the point is positioned in a feature space to indicate the content representation's features (e.g., where clicking on or hovering over a given point can cause information about the content representation to be presented), a list item in a list, etc. Each feature may be determined based on one or more specification values. For example, a feature may be defined to be a weighted sum of specification values. The weights may have been determined by a machine-learning model (e.g., a clustering model and/or component analysis algorithm). The interface may include one or more input components that allow a user to interact with a graph, drop-down menu, radio buttons, text box, etc. to identify any cluster to which a given content representation is to be assigned. In some instances, a graph includes a symbol for each content representation (or each content representation for which a transfer process is to be initiated), where at least one of the coordinates of the symbol is determined based on a feature. A selection tool may then be configured to allow a user to surround multiple symbols (e.g., via a box, oval, free-form area) to identify a cluster. (One or more content representations may then be manually added to or removed from the cluster to fine-tune the cluster.) In some instances, each individual presented point identification of a content representation can be dragged and dropped into a region associated with a given cluster.

As another example, aggregator controller 182 can identify each of any other content representation to which the content representation is related. For any of those other content representations, aggregator controller 182 can identify how it is related to the content representation. Aggregator controller 182 may present an indication (e.g., that includes a tree structure) as to whether and/or how the content representation is related to each of the other content representation(s). An interface in which the presentation is provided may identify whether and/or how various content representations in the tree are linked (e.g., via a conditioned link that permits unlinkage, a solid link, or no linkage). Aggregator controller 182 may further retrieve or identify a current status of each other content representation linked to the content representation and can display the status(es) in the interface.

As yet another example, aggregator controller 182 can identify each listing (e.g., which may include an identification of a single content representation or a set of related content representations) currently associated with a client. An interface can be configured to receive a request to merge one listing with one or more others. Further input may provide a name, description and/or value for the merged listings.

Aggregator controller 182 can link each content representation assigned to a cluster with each other content representation assigned to the cluster using a corresponding link. It will be appreciated that there are two types of links. A first type of link may link content representations automatically based on detected values. For example, the first type of link may link content representations in a family. A second type of link may link content representations that are to be linked in some manner in an initialized transfer environment. For example, the second type of link may indicate—in a listing—that transfer of a given content representation is conditioned on a corresponding transfer of each of one, more, or all of other content representation(s) linked to the content representation being transferred concurrently.

In some instances, different types of links are defined. One type of link may include a solid link, where none of the linked content representations are permitted to be transferred without all of the linked content representations being transferred. One type of link may include a weak link, which allows a transfer of any given content representation without all of the linked content representations. However, a required amount for transferring all or multiple of the linked content representations may have been less than the cumulative sum from all of the individual linked content representations, and/or transferring some or all of the linked content representations may have been associated with reduced constraints. Thus, if constraint controller 180 detects that fewer than all of a linked set of content representations are being transferred, constraint controller 180 may determine whether to redefine the cluster (e.g., to remove the identification of the transferred content representations and to potentially add a representation of each of one or more other content representations) and/or to adjust a required amount and/or one or more constraints of the cluster.

In some instances, in an interface that transfer controller 178 uses to identify content representations available for transfer, a score of each of one or more identified content representation is also identified. The score may have been generated using a machine-learning model trained using data corresponding to a data set of content representations owned and/or controlled by the entity that initiated the potential transfer of the content representation or that owns the content representation. Alternatively or additionally, a presented score can be generated using a machine-learning model trained using data corresponding to a set of different content representations owned and/or controlled by an entity associated with a user system that is accessing and/or viewing the interface. As yet another example, a presented score may be generated by transforming data corresponding to one or more content representations (e.g., indicating a status, a time until expiration, a jurisdiction, a size of a portion of each of the representations, etc.) using a rules-based approach. When multiple content representations are linked by aggregator controller 182, an aggregated score may be generated. The aggregated score may include (for example) a mean, median, sum, or maximum of the scores of the content representations being aggregated. In some instances, AI operation predictor 176 generates a score specifically for the cluster using (for example) specifications of each of the content representations in the cluster and/or scores of each content representation in the cluster.

A reach system 184 can initiate and control listing a content representation (and a corresponding resource) and/or can control at least part of a transfer of the content representation. Listing the content representation can include (for example) presenting information about and/or an object for the content representation in a webpage. The webpage may be interactive to enable a viewer to iteratively request and receive more information about the content representation and/or to request a transfer of the content representation.

In some instances, reach system 184 interacts with constraint controller 180 to determine, upon receiving a transfer request associated with a given content representation, whether each required condition associated with the content representation is satisfied. Even if each solid-link constraint is satisfied, reach system 184 may respond to a transfer request (and/or may precipitate a transfer request by presenting information) to indicate that a given content representation is linked to one or more other content representations and/or is associated with one or more other data values.

Reach system 184 may communicate with AI operation predictor(s) 176 to determine, for a given content representation that that may be or is to be transmitted or presented to another entity, a score associated with the content representation as generated by a machine-learning model trained using training data associated with the other entity. Reach system 184 may then present the score and/or may effect responding to one or more filtering inputs from the other entity based on the score. For example, a filter constraint may request that presentations of content representations be restricted to those over a specific score.

In some instances, reach system 184 determines an order and/or placement of presentations of content representations based at least in part on the corresponding scores associated with a machine-learning model trained using training data associated with a viewing entity. The order and/or placement may be determined at least in part based on a search query received by user system accessing or requesting the presentations and/or one or more content representations associated with (e.g., owned by) an entity corresponding to the user system.

In some instances, reach system 184 determines that a given listing corresponds to metadata indicating a resource-communication limitation applies. In some instances, the resource-communication limitation applies when the listing includes content in a particular portion of the listing (e.g., which may then be defined access-restrained specific information). The particular portion may identify one or more particular encumbrances that apply to the listing.

In these instances, when a request for transfer is detected, reach system 184 may cause a first communication to be sent to a device corresponding to the user requesting (or conditionally requesting) the transfer, where the first communication specifies that a disclosure restriction applies to presentation of the specific information. For example, reach system 184 may prepare a file for execution by the requesting entity, where the file specifies that the requesting entity is not to share or distribute the access-restricted data (unless various specified circumstances exist). When a second communication is received that indicates that the restrictions are accepted, reach system 184 may send a communication to the client that requests execution of the same file. If both the requesting entity and the client execute the file (e.g., within a specified time period), reach system 184 may then grant access (e.g., for a particular time period) of the specific information to the requesting entity, such that the requesting entity can evaluate the specific information in view of a potential transfer circumstance. If either of the requesting entity and the client execute the file (e.g., within a specified time period), the requesting entity may be blocked from receiving the specific information and/or any potential-transfer process may be terminated.

When reach system 184 has determined that all defined transfer conditions have been fulfilled, reach system 184 may require a final transfer authorization from one, more or all of client system 130, an entity owning the content representation to be transferred, and an entity to which the content representation is to be transferred. The authorization may include accepting one or more terms and/or accepting (or again accepting) each applicable transfer constraint. The transfer constraint(s) may include each constraint specifically defined for the content representation and each more general constraint (e.g., that applies to the network controlled by the network controller). A transfer constraint may include receiving a pre-authorization for providing a specified amount for the content representation.

Upon verifying the condition fulfillments, reach system 184 may coordinate the transfer or may effect the transfer. Coordinating or effecting the transfer may include transmitting an assignment for the content representation, monitoring whether an executed version of the assignment has been received, addressing any non-receipt, and/or recording an executed version of the assignment. The transfer may include changing an entity that is to be associated with, to control, or to own the content representation and/or an associated resource. Transferring the content representation may include transferring the resource that is defined by the particular resource.

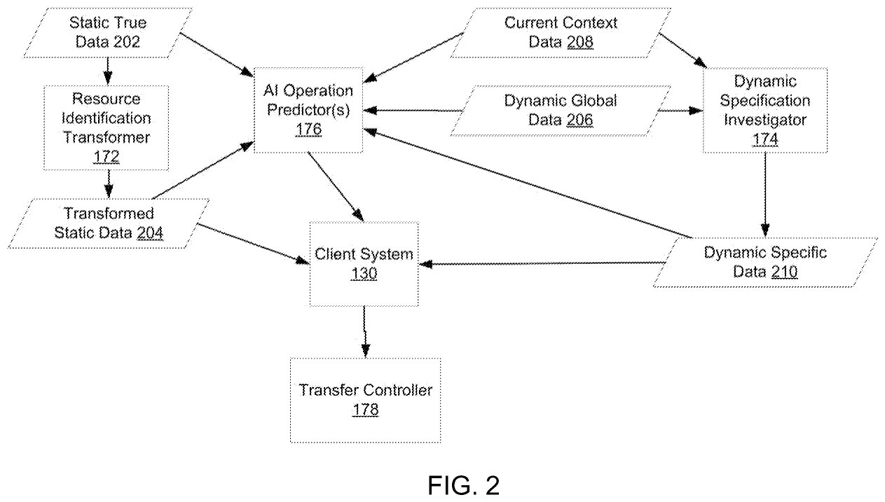

As illustrated in FIG. 2, resource identification transformer 172 can transform each of one or more specifications (static true data 202) pertaining to a given content representation to generate transformed specifications (transformed static data 204). For example, a transformation may include converting a word to a numeric identifier, assigning a number to a number range, normalizing or standardizing a value (based on a normalization determined using a data set), etc. In some instances, transformed static data 204 includes a same value as in static true data 202 (meaning that no transformation was performed for that value).

Similarly, dynamic specification investigator 174 may, but need not, transform data. For example, in the depiction in FIG. 2, dynamic specification investigator 174 retrieves both dynamic global data 206 and current context data 208. Current context data may include information about the given content representation and/or client system 130. Dynamic specification investigator can use current context data 208 to determine dynamic specific data 210 that specifically applies to the context. As another example, dynamic specification investigator 174 may specifically retrieve dynamic specific data 210 that applies to the current context.

AI operation predictor 176 can use some or all of the data retrieved or generated by resource identification transformer 172 and/or by dynamic specification investigator 174 to generate a prediction (e.g., a predicted future value of a specification and/or a predicted score). Some or all of the initially retrieved data (e.g., static true data 202, dynamic global data 206, and/or current context data 208), some or all of the generated data (e.g., transformed static data 204 and/or dynamic specific data) and/or some or all of the predicted data (e.g., one or more predicted future values of one or more specifications and/or the predicted score) can be transmitted to client system 130. Client system 130 can present some of or all of the received data and receive an instruction (e.g., via a user interface) to initiate a transfer-facilitation process. The instruction may have been explicitly identified for the given content representation, the instruction may be for a transfer-facilitation process to be initiated for any content representation (in a list of content representations) for which a decision has been made to not perform an upcoming action, or the instruction may be for the transfer-facilitation process to be initiated for any content representation (in a list of content representations) that is associated with a predicted score that is below a defined threshold. Client system 130 can transmit the instruction to transfer controller 130, which can then distribute information about content representation(s) corresponding to the instruction.

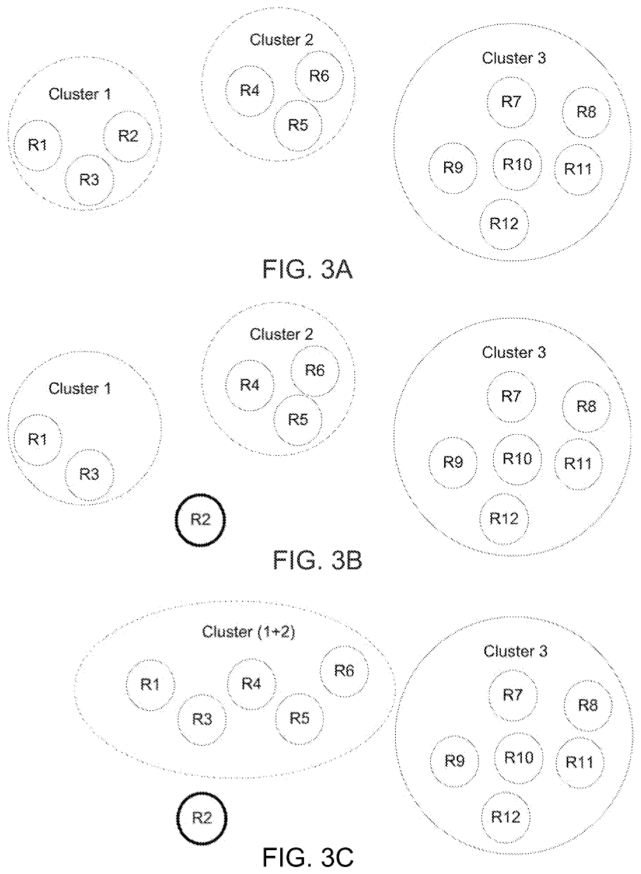

FIGS. 3A-3C illustrate aggregations of content representations into clusters. Each small circle corresponds to an individual content representation. In FIG. 3A, three content representations (R1-R3) are aggregated into a first cluster, two content representations (R4-R6) are aggregated into a second cluster, and seven content representations (R7-R12) are aggregated into a third cluster. (While not shown here, in some instances, a content representation may be assigned to multiple clusters.) Aggregator controller 182 may have automatically defined the clusters or defined the clusters based on cluster-definition information received from a client system. Content representations in a cluster may be related to each by (for example) technological similarity, being a part of a same family tree, or as a result of a client instruction to generate the cluster or a merging that includes the content representations. Thus, a cluster may be automatically generated by (for example) identifying content representations with a same technological-field identifier (e.g., same art unit, same class, same technology center, etc.) and/or identifying each content representation in a tree representing continuity and priority data.

Content representations in the third cluster are linked via a solid link that does not permit transferring one of the linked content representations without the transfer including the rest of the content representations in the third cluster. Meanwhile, content representations in the first cluster are linked together via a weak link, which permits transferring an incomplete subset of the content representations in the cluster. Thus, reach system 184 can associate each of R1-R3 with an individual listing value (whereas those in the third cluster need not). Reach system 184 may further associate the first cluster with a cluster listing value (as might the second cluster and third cluster), which may be less than a sum of the individual listing values of the cluster.

Any of the first, second or third clusters may further serve to facilitate or control presentations identifying the content representations. For example, after a client has requested and approved that a transfer-facilitation process be initiated for content representations R1-R3, reach system 184 can generate a content-representation-specific webpage on a website for each of the individual content representations R1-R3 and potentially another webpage on the website can be generated for Cluster 1. The content-representation-specific webpage may include part or all of the content representation, metadata pertaining to the content representation, a status of the content representation (e.g., which, if any, amounts due have been paid; any upcoming maintenance deadline), a remaining term of the content representation, any constraint that applies to transfer of the content representation, a listing value for the content representation, an indication that R1 is linked to R2 and R3, an identification each of R2 and R3 (e.g., via a name and number identifier), a listing value for R1, and a listing value for Cluster 1 (which may be the sum of the listing values of R1, R2 and R3 or another value as specified by the client).

Reach system 184 can configure the website to receive search queries from a user. A search query may include an identification of a technology area (e.g., a technology center, an art unit group or class assignment), an identification of a subject matter (e.g., that is to be included in a name of the content representation and/or in text of the content representation), a limit on a remaining term (e.g., to request that returned content representations have at least a specified remaining term), a limit on a score (e.g., to request that returned content representations be associated with a score that is above a specified threshold), a limit on a listing value (e.g., where the limit applies equally to clusters and individual content representations or is per content representation), and/or any constraints on transfer that are (or are not) acceptable. The score may have been generated by AI operation predictor 176 using a model disclosed herein to predict whether an entity associated with the user, whether the client, or whether one or more other entities would complete a maintenance task to keep the content representation active. Thus, the model may have been trained using training data associated with the entity associated with the user, training data associated with the client, or training data associated with the one or more other entities.

Reach system 184 may query a data store to identify content representations that match the search query. Reach system 184 can generate a search-result webpage that identifies each of some or all of the content representations that match the search query. The identification can include (for example) a name (title of a content representation), number identifier (patent number), a representation (e.g., via a symbol that is defined in a legend) of any applicable transfer constraint, and/or exemplary figure. In some instances, the result identifications are filtered and/or ordered based on information pertaining to how closely each of one, more, or all features or specifications of each result matches each of one, more or all features or specifications of content representations of the users or specified by the user system (e.g., in the search query). For example, a central point in a feature space may be identified for the user system (or an entity associated with the user system) by averaging features of content representations controlled by the entity associated with the user system or based on the query. For each query result, a distance between a point in the feature map corresponding to the result and the central point may be determined, and the query results may be filtered or ordered based on the distances.

The identification can further include a link to a content-representation-specific webpage that includes more information about the content representation. In some instances, when a content representation that matches the search query is part of a cluster (e.g., any cluster or a cluster that includes solid links), search-result webpage identifies the cluster instead of identifying the content representation (e.g., via a client-identified or automatically generated name, identifying each content representation in the cluster, and/or identifying a number of content representations in the cluster).

FIG. 3B illustrates an instance where a user requests transfer of content representation R2. Because R2 is in a cluster with weak links, aggregator controller 182 can determine that a transfer of an incomplete subset of the content representations is permitted. (Meanwhile, reach system 184 may configure the website to not accept a request to transfer only one of the content representations from the third cluster, or aggregator controller 182 may respond to any such request with an error.) The request may initiate a communication series—facilitated by reach system 184—to ensure that user accepts any constraints that apply to the transfer and also that payment for the content representation is confirmed. In some instances, the communication series may further include availing an electronic object to the user system (e.g., that includes a signature associated with the client that initially provided the content representation) and requesting (e.g., electronic) signature. The electronic object may then be uploaded to a third-party computing system. For example, the electronic object may include an assignment document, and the third party computing system may be a computing system of an entity that examines content representations. Thus, uploading the signed document may result in assigning an enhanced version of a content representation (corresponding to R2) from the client to the entity associated with the user.

As a result of R2 being transferred, Cluster 1 includes fewer content representations. Thus, in some instances, aggregator controller 182 can redefine one or more clusters. For example, FIG. 3C shows an instance where Clusters 1 and 2 are merged into Cluster (1+2). In some instances, aggregator controller 182 automatically identifies multiple clusters to merge when a merge condition is satisfied. For example, a merge condition may be defined to be satisfied when at least one cluster has a size below a threshold, a total size of two or more of the smallest clusters is below a threshold, and/or a total size of two or more clusters that are separated by less than a distance threshold in a feature space is below a size threshold). The clusters that are merged or proposed for a merge may be defined based on sizes of individual clusters and/or potentially the features or specifications that correspond to individual clusters. For example, a condition may be defined to identify whether a total size of the smallest two clusters that include content representations that had been examined in a same technology center is below a size threshold, and the two smallest clusters can be selected for a merge or proposed merge.

In some instances, when the merge condition is satisfied, a communication is sent to client system 130 that identifies the sizes of some or all clusters and/or that identifies a proposed merge. A merge may be effected upon receiving a client instruction to complete the merge. In some instances, a merge is automatically completed upon detecting that the merge condition is satisfied and identifying the clusters to be merged. In some instances, a merge condition and/or protocol is defined based on input from client system 130 and/or is accepted by client system 130 and the merge protocol is then automatically implemented for clusters pertaining to the client.

For each content representation for which transfer facilitation has been initiated, transfer controller 178 can query an external source to determine whether and/or how it is connected with any other content representation(s) via continuity and priority data. In some instances, each query is centered on a single content representation. When a query indicates that a given content representation is related to another content representation, another query may be performed centering on the other content representation. This approach may be iteratively performed (querying one or more data sources) until no new content representation identifications are returned. Transfer controller 178 can then use the query results to build a tree or web that indicates how the various content representations are related. The same or different queries may further identify a status (e.g., pending, published, allowed, issued) and/or date information (e.g., an issue date) for each content representation, which may be integrated into the tree or web.

When transfer controller 178 receives a request from a client system 130 to initiate a transfer-facilitation process for one or more content representations, transfer controller 178 may determine whether, for each of the one or more content representations, all other content representations in a tree associated with the content representation is included in the one or more content representations. If not, transfer controller 178 may transmit a communication to client system 130 that includes the tree and queries whether the client would like for a transfer-facilitation process to be initiated for the other content representation(s). The tree may further be used to automatically identify a cluster (that is defined to include all content representations in the tree) or to suggest a cluster (that is defined to include all content representations in the tree) to a client. Further, the tree or a representation of the tree may be included in a content-representation-specific webpage (for each content representation identified in the tree) or a cluster-specific webpage.

For each of one or more content representations for which a transfer is being initiated, transfer controller 178 may further use one or more data objects and/or one or more data sources to confirm that at least part of the listing is accurate. For example, transfer controller 178 may use one or more files (e.g., electronic versions of one or more assignments uploaded from client system 130) and/or an assignment database to determine whether the client controls the content representation. Confirming accuracy may include (for example) confirming a contiguous chain of entity-to-entity transfers that end with the client that requested transfer facilitation. Confirming the contiguous chain of transfers can include confirming that some level of verification of each transfer in the chain has been received or accessed, confirming that there is no break in the chain, and/or confirming the accuracy of each prior transfer in the chain. In some instances, transfer controller 178 can perform any of one or more levels of verification to confirm accuracy of a prior transfer. For example, a bottom level may include confirming that a client has attested to the accuracy; a second level may include an availing to a user of one or more files provided by client system 130; a third level may include an automated verification review (e.g., configured to detect signatures and/or one or more keywords or concepts) and an availing of the one or more files provided by client system 130; a fourth level may include a human review of uploaded documents to confirm that the file(s) conform with one or more specified requirements; and a fifth level may include a review by a human professional that attests that the file(s) conform with one or more specified requirements. In some instances, the level of verification that is performed depends on which level was selected and supported by the client (e.g., for the particular content representation, for the client account, etc.). In some instances, the level of verification that is performed or for which results are availed is determined by a level of verification that is requested by or provided for by a user system.

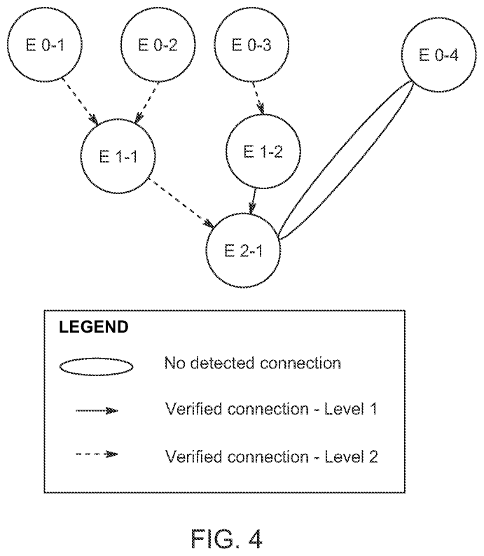

FIG. 4 illustrates an exemplary representation of verification results for a tree corresponding to a particular content representation that entity E 2-1 requested be initialized for transfer facilitation. Transfer controller 178 then uses uploaded files and data from one or more databases to verify that there is a complete chain from each entity E 0-* initially at least partly controlling the content representation (E 0-1 through E 0-4) to entity E 2-1. This may involve tracking each transfer, which may one or more divergent transfers (e.g., a transfer from one entity to multiple entities) to ensure that all transfers end with entity E 2-1. For example, in FIG. 4, each of E 0-1, E 0-2, E 0-3, and E 0-4 may be an inventor, each of E 1-1 and E 1-2 may be a co-applicant. E 2-1 may be a different entity to which each of the co-applicants assigned their rights in the content representation. In the illustration in FIG. 4, some level of verification of the transfers from each of E 0-1 to E 0-3 may have been performed. A level of verification performed for the transfers of E 0-1 to E 1-1, E 0-2 to E 1-1, E 0-3 to E 1-2 and E 1-1 to E 2-1 may be higher than a level of verification performed for the transfer of E 1-2 to E 2-1.

The level of verification may be conveyed in a representation of the verification results. For example, a color, thickness, line style, or text that is associated with a connection between two entities may represent a level of verification. In the exemplary instance of FIG. 4, a thinner line connects E 1-2 and E 2-1 as compared to most other connections. Meanwhile, transfer controller 178 identified no information that indicated that E 0-4 was connected to E 2-1. The representation of the verification results can be provided to a client system (e.g., prior to or after confirming a listing of a content representation) and/or to a user system (upon viewing an identification of a content representation in the tree). That is, the representation of the verification results may help a client to tighten information corresponding to one or more listings and/or may help a user to understand specifications of a given content representation or cluster.

While FIG. 4 includes a graphical representation that identifies relationship between entities and the current verification of transfers between entities, other representations are contemplated. For example, a table, list, or text may convey similar information.

Any representation may be interactive. For example, a client may be able to interact with a connection representing some level of verified transfer or unverified transfer (e.g., click on and upload a file or provide a link) to provide additional verification of the transfer. As another example, a user may be able to interact with a connection representing some level of verified transfer or unverified transfer to initiate a request to be sent to the client or to transfer controller 178 for additional verification of a transfer. The interaction may include (for example) double clicking on the connection, selecting one or more input options, and/or providing one or more input option (e.g., to indicate a source for an additional verification or to upload or provide information that provides an additional verification).

In some instances, providing additional verification may automatically initiate or may cause—upon request—one or more scores associated with one, more or all of the content representations identified in the tree to be updated.

### EXAMPLES

### Example 1

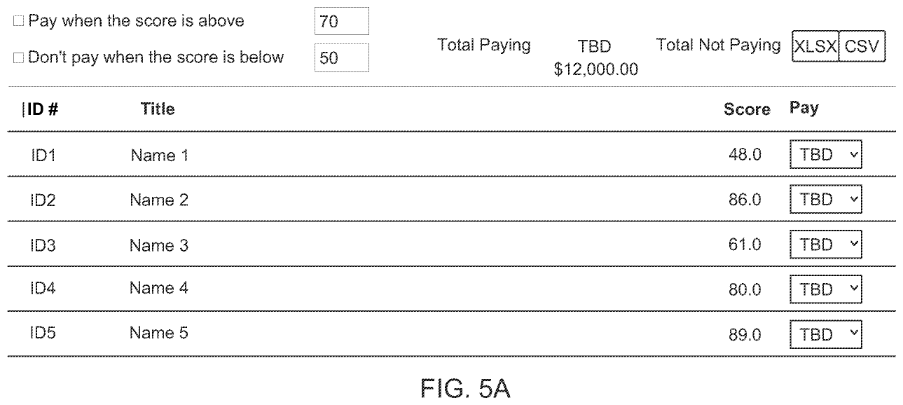

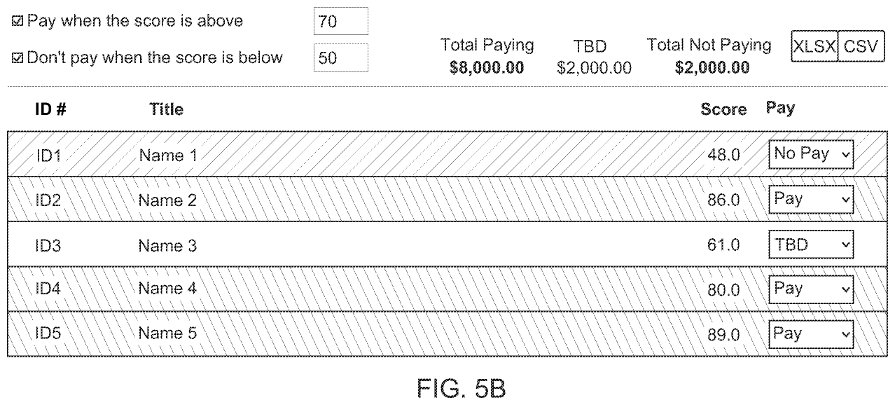

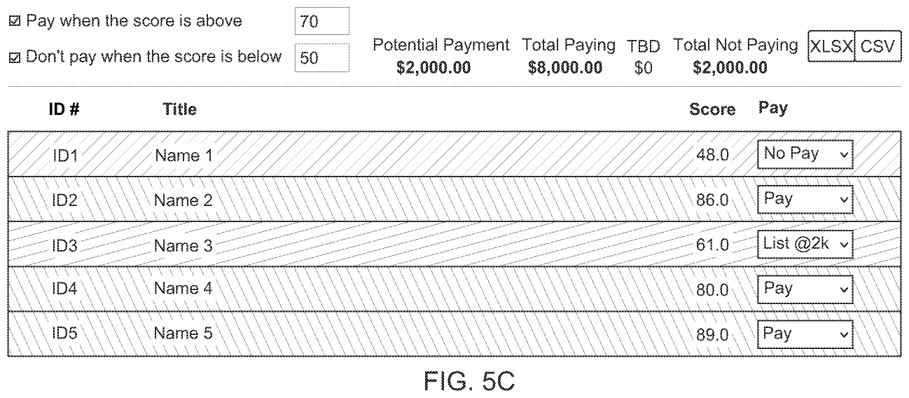

FIGS. 5A-5C show exemplary interfaces for facilitating decisions pertaining to content representation. FIG. 5A shows an interface (generated by transfer controller 178) that includes identifiers and names of five content representations. For each of the content representation, a score (generated by AI operation predictor 176) is also presented that identifies a predicted likelihood that an entity associated with a user accessing the interface will complete an upcoming task. The top of the interface includes input components that define and/or can affect default limits for the score indicating when the upcoming task will or will not be completed. In FIG. 5B, each of these default limits are effected. This results in a listing of each of four of the content representations changing its specified action decision from TBD (To Be Determined) to the corresponding default decision. Despite these updates, any one of the action identifiers may still be changed using the drop-down input component. Further, for one content representation, no default decision is identified. In response to the implementing of these defaults, multiple cumulative resultant values are updated.

FIG. 5C shows an interface where an input component presents an option of initiating a transfer processing (or listing) a content representation. In the depicted instance, this option was selected for the third content representation. A listing value may have been pre-identified based on one or more general rules, one or more client-defined rules, and/or one or more specifications relating to the content representation. For example, the listing value may be identified based on a term that remains for the content representation to be active or for which maintenance action(s) has yet to be completed.

### Example 2

A client system requests initiation of transfer facilitation for each of a set of content representations. Resource identification transformer 172 and/or dynamic specification investigator 174 identifies one or more specifications for each of the set of content representations. AI operation predictor 176 identifies a position within a feature space for each of the content representations based on the specification(s) associated with the content representation. Reach system 184 detects that the position of at least a threshold quantity or at least a threshold percentage of the set of content representations is within a predefined distance from a position associated with a query previously received by and/or defined by a user system. Reach system 184 sends a communication to the user system that includes an alert of at least some of the set of content representations.

To be claimed:

1. A system comprising:
a dynamic specification investigator that determines, for each content representation of a set of content representations and based on data from at least one data source, a set of specifications of the content representation, wherein each content representation defines a resource, and wherein at least one specification that characterizes a point along a navigation towards the corresponding resource;
an artificial-intelligence (AI) operation predictor that:
predicts, for each specification of the set of specifications corresponding to each of at least one the set of content representations, a value for the specification; and
determines, for each of the at least one of the set of content representations, a score for the content representation based at least in part on the predicted value of each of the set of the specifications corresponding to the content representation;
a transfer controller that:
presents the score for a particular content representation of the set of content representations and an input component configured to receive an indication as to whether to initiate a transfer process for the particular content representation; and
detects an input via the input component that indicates that the transfer process is to be initiated for the particular content representation; and
a reach system that initiates the transfer process for the particular content representation.

2. The system of claim 1, further comprising a constraint controller that:
detects, for a content representation of the set of content representations, one or more constraints that apply to transfer of the content representation; and
constrains the reach system in terms of the output generation or updating so as to not initiate a discordance of the one or more constraints.

3. The system of claim 1, further comprising a constraint controller that detects, for a particular content representation of the set of content representations, one or more constraints that apply to transfer of the content representation;
wherein the reach system is further configured to receive a request for the content representation;
wherein the constraint controller is further configured to verify that the request accords with the one or more constraints.

4. The system of claim 1, wherein:
the score determined by the AI operation predictor pertains to a particular entity;
the AI operation predictor further determines, for each of at least one of the set of content representations, another score for the content representation corresponding to another entity, wherein the score is higher than the other score; and
the reach system preferentially generates or preferentially updates an output corresponding to the potential transfer of the particular content representation to the particular entity over that to the other entity based on the score being higher than the other score.

5. The system of claim 1, further comprising:
an aggregator controller that generates multiple clusters of content representations across the set of content representations, the content representation being assigned to a particular cluster of the multiple clusters;
wherein the AI operation predictor further aggregates the score for the content representation with each other score corresponding to other content representations in the cluster;
wherein the transfer controller presents the aggregated score.

6. The system of claim 1, wherein, for a particular specification of the set of specifications, the AI operation predictor predicts the value using a Bayesian computation.

7. The system of claim 1, wherein transfer of the particular content representation includes transfer of the resource defined by the particular content representation.

8. A system comprising:
a resource identification transformer that identifies one or more specifications of a content representation of a resource;
a dynamic specification investigator that detects a value of one or more dynamic specifications; and
an AI operation predictor that:
projects a subsequent version of the content representation based on the one or more specifications of the content representation and the one or more dynamic specifications;
transmits one or more values of the subsequent version of the content representation; and
receives, in response to the transmission, an instruction to modify a workflow for upkeeping the content representation; and
a reach system that initiates a transfer process for the content representation.

9. The system of claim 1, wherein the value of the one or more dynamic specifications includes a status of each of one or more other resources.

10. The system of claim 1, wherein the one or more values of the subsequent version of the content representation includes a value acceptable via a rule of a transfer-control system for listing the content representation, and wherein the instruction to modify the workflow includes an instruction to list the content representation for the value at the transfer-control system.

11. The system of claim 1, wherein the one or more values of the subsequent version of the content representation include a predicted probability of a given entity performing an action to maintain an existence of the resource and the one or more dynamic specifications includes a status of each of one or more other resources.

12. The system of claim 1, wherein modifying the workflow includes changing a state of a switch that indicates whether a given action is to be initiated.

13. The system of claim 1, wherein the workflow includes multiple lines of action, wherein each of the multiple lines of action is initiated by a trigger, and wherein the modification of the workflow by the trigger controller comprises setting a trigger of at least one of the multiple lines.

14. The system of claim 1, wherein modifying the workflow includes modifying a representation of a task in the workflow to facilitate transforming the resource from a first state to a second state.

15. The system of claim 1, wherein the subsequent version of the content representation is projected by using a probabilistic map that relates content-representation features to probabilities of at least one action within the workflow being performed.

16. The system of claim 1, wherein the projected subsequent version of the content representation at the subsequent time represents a prediction corresponding to whether an enhanced version of the content representation will have been obtained.

17. A system comprising:
a resource identification transformer that:
identifies a set of distinct content representations, each of the set of distinct content representations corresponding to a resource;
transforms each of the set of distinct content representations include a reduced-content representation; and
facilitates presenting the reduced-content representations at a first interface associated with a client system;
an aggregator controller that:
detects that a trigger was received at the interface for generating a cluster for two or more of the set of distinct content representations;
links the two or more content representations via a link;
a reach system that:
receives, via a second interface, a request that includes one or more content specifications; and
a transfer controller that:
detects that the one or more content specifications correspond to a first content representation of the two or more content representations; and
detects that the first content representation is linked to each other of the two more content representations, wherein the reach system is further configured to facilitate a presentation indicating that the first content representation is linked to each other of the two or more content representations.

18. The system of claim 17, wherein the aggregator controller further:
determines that the link is a weak link that permits removal of any individual content representation of the two or more content representations from the cluster.

19. The system of claim 17, wherein:
the two or more of the set of distinct content representations include three or more of the set of distinct content representations;
the aggregator controller further determines that the link is a weak link that permits removal of any individual content representation of the two or more content representations from the cluster;
the reach system detects a transfer request for a particular individual content representation from the cluster;
the aggregator controller, in response to the transfer request or a corresponding related action, redefines the cluster; and
the redefined cluster does not include the particular individual content representation.

20. The system of claim 17, wherein the aggregator controller:
for each resource of a set of resources corresponding to a client:
identifies a set of features based on specifications corresponding to the resource;
generates a point in a multi-dimensional space based on the set of features; and
generates a presentation that includes a graphical representation of the points and that facilitates groupings of each of one or more subsets of the points to identify a corresponding cluster, wherein the interface displayed the presentation, wherein the cluster was generated in response to a user-identified grouping of the two or more of the set of distinct content representations, and wherein each of the two or more of the set of distinct content representations included a corresponding generated point in the multi-dimensional space.
